(19) United States
(12) Patent Application Publication
(10) Pub. No.: US 2026/0339524 A1
(43) Pub. Date: Oct. 29, 2026

(54) SELECTIVE TRANSMISSION OF DATA STORED IN REDUNDANT MEMORY DEVICES OF A MEMORY SYSTEM

(71) Applicant: The Boeing Company, Arlington, VA (US)

(72) Inventors: Tuan QUACH, San Clemente, CA (US); Baongoc NGUYEN, Anaheim, CA (US); David LARUE, Torrance, CA (US); Willis HOANG, Los Angeles, CA (US); Brad RASMUSSEN, Rancho Palos Verdes, CA (US); Tyler THRANE, Manhattan Beach, CA (US)

(21) Appl. No.: 19/191,867

(22) Filed: Apr. 28, 2025

(51) Int. Cl. G06F 3/06

(52) U.S. Cl. CPC G06F 3/0619; G06F 3/0646; G06F 3/0673

(57) ABSTRACT

In some implementations, a memory system may receive a read command associated with data to be read from memory, where a first copy of the data is stored in a first memory device associated with the memory system, and where a second copy of the data is stored in a second memory device associated with the memory system. The memory system may determine whether the first copy of the data or the second copy of the data includes an error. The memory system may selectively transmit the first copy of the data from the first memory device or the second copy of the data from the second memory device based on determining whether the first copy of the data or the second copy of the data includes the error.

### FIELD

The present disclosure relates generally to memory systems and memory systems having to redundant memory devices or channels.

### BACKGROUND

Memory devices are widely used to store information in various electronic devices. A memory device includes memory cells. A memory cell is an electronic circuit capable of being programmed to a data state of two or more data states. In some examples, a memory cell is capable of being programmed to a data state that represents a single binary value, often denoted by a binary “1” or a binary “0.” As another example, a memory cell is capable of being programmed to a data state that represents a fractional value (e.g., 0.5, 1.5, or the like). To store information, an electronic device writes to, or programs, a set of memory cells. To access the stored information, the electronic device reads, or senses, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. A memory device may be associated with a double data rate (DDR) memory device. A DDR memory device is a type of SDRAM device that transfers data on both the rising and falling edges of the clock signal, effectively doubling the data rate of the memory system as compared to a single data rate (SDR) memory device.

### SUMMARY

An embodiment of the present disclosure provides a memory system, comprising: a first memory device; a second memory device; and a memory system controller operatively coupled to the first memory device and the second memory device, the memory system controller configured to: receive, from a processor, a read command associated with a first set of data to be read from memory, wherein a first copy of the first set of data is stored in the first memory device, and wherein a second copy of the first set of data is stored in the second memory device; determine whether the first copy of the first set of data or the second copy of the first set of data includes an error; and selectively transmit, to the processor, the first copy of the first set of data from the first memory device or the second copy of the first set of data from the second memory device based on the determination of whether the first copy of the first set of data or the second copy of the first set of data includes the error.

Another embodiment of the present disclosure provides a method, comprising: receiving, by a memory system from a processor, a read command associated with a first set of data to be read from memory, wherein a first copy of the first set of data is stored in a first memory device associated with the memory system, and wherein a second copy of the first set of data is stored in a second memory device associated with the memory system; determining, by the memory system, whether the first copy of the first set of data or the second copy of the first set of data includes an error; and selectively transmitting, by the memory system to the processor, the first copy of the first set of data from the first memory device or the second copy of the first set of data from the second memory device based on determining whether the first copy of the first set of data or the second copy of the first set of data includes the error.

Yet a further embodiment of the present disclosure provides a non-transitory computer-readable medium storing a set of instructions, the set of instructions comprising: one or more instructions that, when executed by one or more processors of a memory system, cause the memory system to: receive a read command associated with a first set of data to be read from memory, wherein a first copy of the first set of data is stored in a first memory device associated with the memory system and wherein a second copy of the first set of data is stored in a second memory device associated with the memory system; determine whether the first copy of the first set of data or the second copy of the first set of data includes an error; and selectively transmit the first copy of the first set of data from the first memory device or the second copy of the first set of data from the second memory device based on determining whether the first copy of the first set of data or the second copy of the first set of data includes the error.

The features, functions, and advantages described herein can be achieved independently in various implementations or can be combined in other implementations, further details of which are shown in the drawings and described below.

### BRIEF DESCRIPTION OF THE DRAWINGS

FIG. 1 is a diagram illustrating an example system capable of selective transmission of data stored in redundant memory devices of a memory system.

FIG. 2 is a diagram of an example memory system associated with selective transmission of data stored in redundant memory devices.

FIG. 3 is a diagram of an example implementation associated with Hamming-5 error detection and correction (EDAC) protection of data stored in redundant memory devices of a memory system.

FIG. 4 is a diagram of an example environment in which systems and/or methods described herein may be implemented.

FIG. 5 is a diagram of example components of a device associated with selective transmission of data stored in redundant memory devices of a memory system.

FIG. 6 is a flowchart of an example process associated with selective transmission of data stored in redundant memory devices of a memory system.

### DETAILED DESCRIPTION

The following detailed description of example implementations refers to the accompanying drawings. The same reference numbers in different drawings identify the same or similar elements.

Modern memory systems, such as DDR-based memory systems, are increasingly susceptible to reliability concerns due to various error mechanisms. Among these, single event functional interrupts (SEFIs) pose a significant challenge, as they can cause entire memory banks or controllers to become unresponsive due to radiation-induced upsets. Additionally, or alternatively, failure in time (FIT) events, which measure the probability of errors over a given period, may affect a reliability of a memory device. As memory density increases and operating voltages decrease, these devices become more vulnerable to soft errors caused by cosmic rays and alpha particles, leading to data corruption, system crashes, or performance degradation.

Mitigation of such errors is important, particularly in mission-critical applications such as aerospace or satellite applications, among other examples. Conventional error correction techniques, such as Error Correction Codes (ECCs), provide some mitigation, but may not fully prevent catastrophic failures caused by SEFIs or accumulated FIT-related errors. There remains a need for improved error detection, correction, and fault-tolerant designs that enhance DDR memory reliability while maintaining performance efficiency.

Some implementations described herein are directed to redundant memory channels (e.g., redundant DDR memory channels) to enable bit error auto-correction, memory part failure detection, and data recovery. In some implementations, a memory system includes multiple memory devices or channels, such as a first or primary memory device or channel, and a second or redundant memory device or channel. In such implementations, a memory system controller is configured to dynamically determine which of the memory devices or channels an access request is to be serviced from, such as by determining if either of the memory devices or channels includes an error. For example, when the memory system controller receives, from a processor (e.g., a host system), a read command associated with data to be read from memory, the memory system controller dynamically determines which copy of data is to be returned to the processor, such as by determining whether a first copy of the data stored in the first memory device or a second copy of the data stored in the second memory device includes an error. The memory system controller thus selectively transmits, to the processor, the first copy or the second copy of the data based on the determination of whether the first copy or the second copy of the data includes the error. As a result, such memory systems (e.g., DDR memory systems or satellite-based memory systems) exhibit improved reliability in the face of SEFI or FIT events as compared to traditional memory systems employing a single memory device or channel, resulting in improved memory operations, decreased memory errors, and thus a reduction in memory, storage, power, and other resource consumption otherwise required for correcting memory errors.

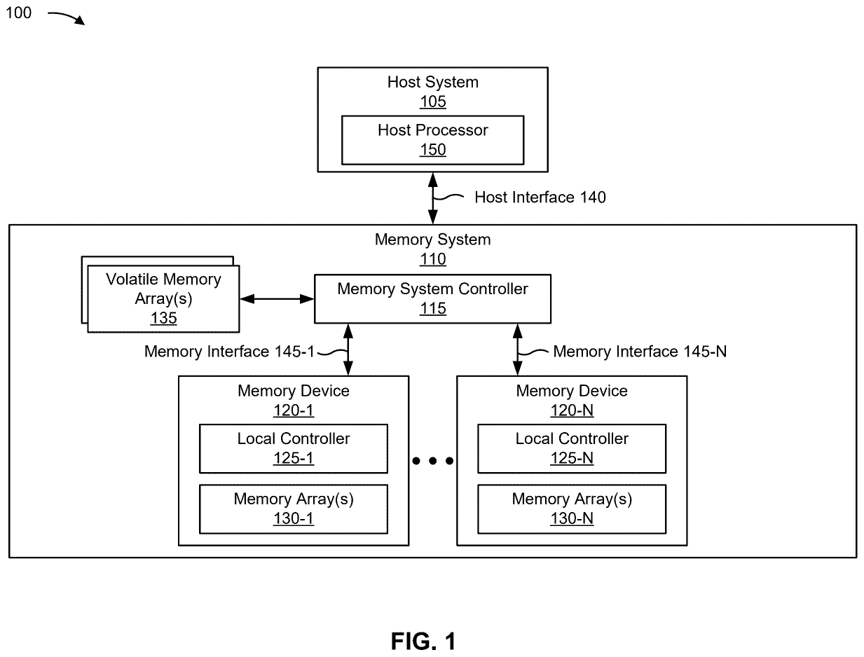

FIG. 1 is a diagram illustrating an example system 100 capable of selective transmission of data stored in redundant memory devices of a memory system. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

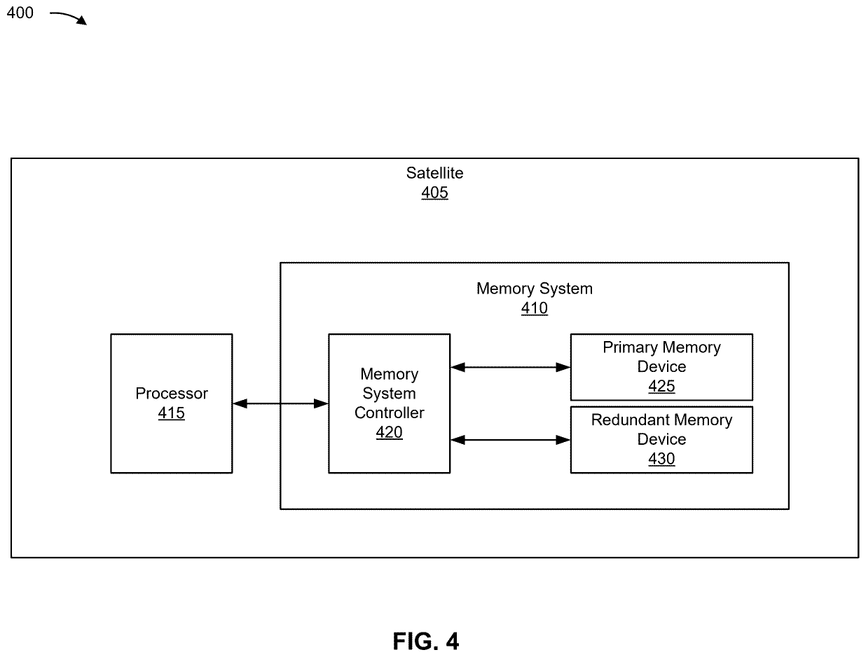

The system 100 may be any electronic device configured to store data in memory. As described in more detail below in connection with FIG. 4, the system 100 may be a satellite, may be associated with a satellite, or may otherwise be associated with a space or aerospace application. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a DDR device, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array, a DRAM array, or an SDRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a DDR interface, a compute express link (CXL)/PCIe interface, an Advanced extensible Interface (AXI), and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

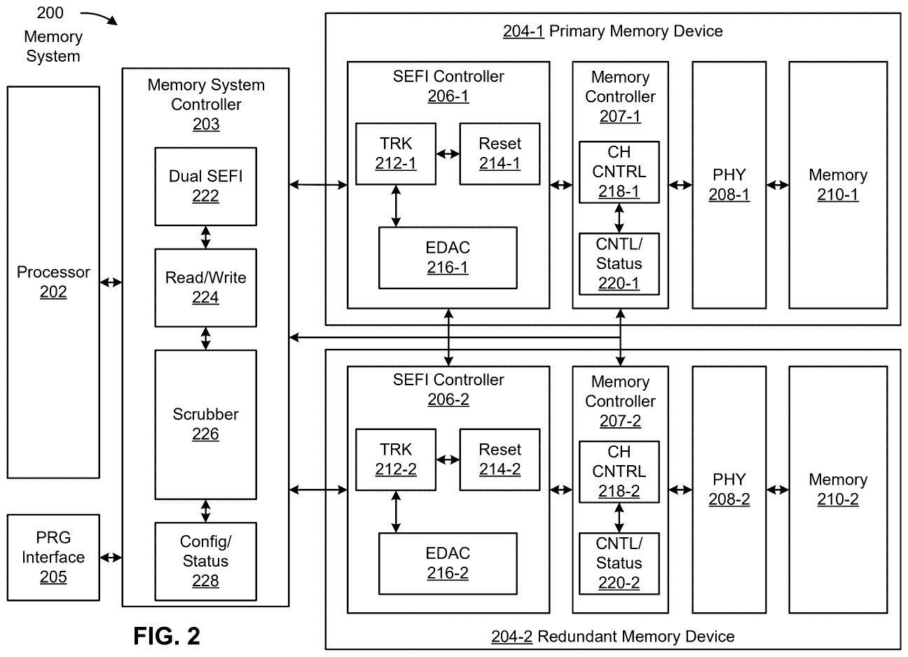

FIG. 2 is a diagram of an example memory system 200 associated with selective transmission of data stored in redundant memory devices. As shown in FIG. 2, the memory system 200 may be in communication with a processor 202 (e.g., host processor 150) via an interface (e.g., host interface 140), such as an interface associated with the AXI protocol, among other examples. The memory system 200 may include a memory system controller 203 (e.g., memory system controller 115), multiple memory devices 204 (e.g., memory devices 120) or channels, including a primary memory device 204-1 (e.g., a device associated with a primary memory channel) and a redundant memory device 204-2 (e.g., a device associated with redundant memory channel), and a programming interface 205. Each memory device 204 or channel includes a SEFI controller 206, a memory device controller 207 (e.g., local controller 125), a physical (PHY) layer interface component 208, and memory 210 (e.g., memory arrays 130), such as SDRAM in implementations associated with DDR memory. Each SEFI controller 206 includes a SEFI tracking component 212, a reset controller 214, and an error detection and correction (EDAC) component 216, among other examples. Each memory device controller 207 includes a channel controller 218 and one or more control/status registers 220, among other examples.

The memory system controller 203 includes numerous components configured to control the memory devices 204 in parallel and/or to control reset, scrubbing (e.g., an operation in which the memory system 200 reads every location in the memory 210 sequentially and writes back any corrected data to the memory 210, which is described in more detail below), and data mirroring operations at the memory devices 204 to ensure data coherency, including a dual SEFI component 222 configured to interface with the SEFI controllers 206 of the memory devices 204, a read/write component 224 configured to read data from, and write data to, the memory devices 204, a scrubber component 226 configured to perform scrubbing operations on the memory devices 204, and a configuration/status component 228 configured to communicate with the programming interface and/or receive programming or configuration information associated with the memory devices 204, among other examples.

In this way, the system 200 includes two identical memory channels (e.g., two identical DDR channels), such as a first memory channel associated with the primary memory device 204-1 and a second memory channel associated with the redundant memory device 204-2. Accordingly, the same read and write commands are sent to both channels and/or memory devices 204, resulting in redundant memory processes and thus more reliable memory operation. For example, when the memory system controller 203 receives, from the processor 202, a write command, the memory system controller 203 (e.g., the read/write component 224 of the memory system controller) writes a first copy of data to the primary memory device 204-1 (e.g., the memory 210-1 of the primary memory device 204-1) and writes a second copy of the data to the redundant memory device 204-2 (e.g., the memory 210-2 of the redundant memory device 204-2).

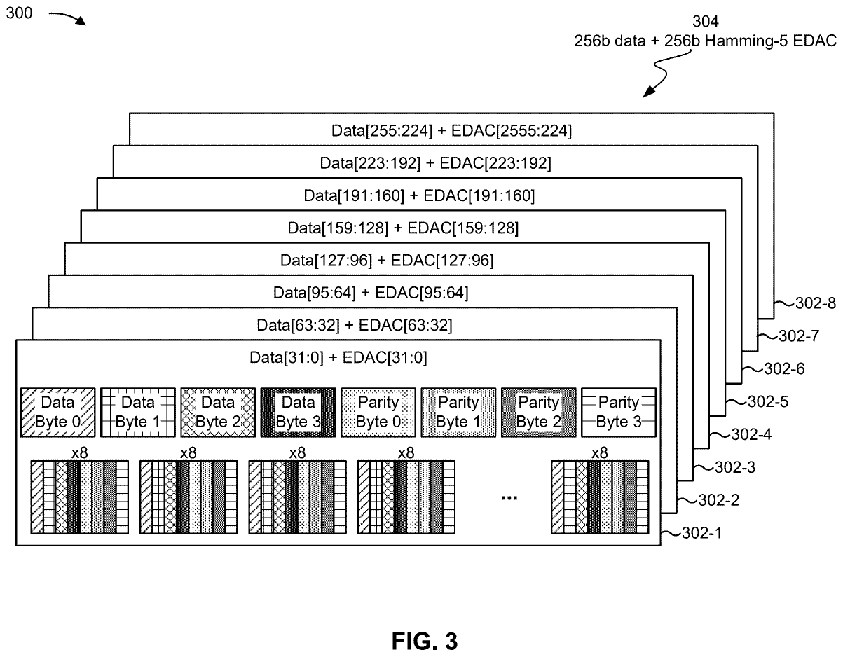

In some implementations, the copies of the data at the memories 210 are associated with EDAC protection, such as Hamming-5 EDAC protection. In such implementations, each data word written into the memory 210 is associated with EDAC protection, such as Hamming-5 EDAC protection, among other examples. Accordingly, writing data to the primary memory device 204-1 and the redundant memory device 204-2 includes determining (e.g., by the respective EDAC components 216 of the SEFI controllers 206) parity bits for a data word to be written to the memory 210 and storing the parity bits with the data in the memory 210. In some other implementations, the copies of the data at the memories 210 are associated with an EDAC protection other than Hamming-5 EDAC protection, such as single-bit error correction, double-bit error detection (SECDED) protection or Hamming-3 EDAC protection, among other examples. Aspects of protecting each data word written into the memory 210 using EDAC protection, such as Hamming-5 EDAC protection, are described in more detail below in connection with FIG. 3.

In some implementations, the memory system controller 203 may write the data to memory devices 204 using a read modify write (RMW) operation. For example, in implementations in which the memory devices 204 are DDR devices, a write granularity may be 32 bytes. Accordingly, for write operations of less than 32 bytes, write data may be merged into existing 32 bytes of data in the memory 210. In such implementations, the write data may be stored (e.g., in an RMW data buffer or similar memory associated with a partial write queue) while an RMW read command is issued to the memory 210 (e.g., a read command associated with the 32 bytes into which the write data is to be merged). If the read data includes no errors (e.g., as determined by the corresponding EDAC component 216), the read data is stored in the RMW data buffer. Moreover, if the read data includes a correctable error (e.g., as determined by the corresponding EDAC component 216), the read data is corrected and the corrected data is stored in the RMW data buffer. Moreover, the write data and the read data are merged in the RMW data buffer based on write data strobes. The merged data is then written back to the memory 210 and the write data is deallocated from the RMW data buffer. In some implementations, a depth of a partial write queue associated with the RMW data buffer is set to eight. In implementations associated with the RMW operation described above, after the write data and the read data are merged (e.g., in the RMW data buffer), the new ECC check bits (e.g., parity bits) are generated based on the merged data and stored with the merged data in the memory 210.

Moreover, when the memory system controller 203 receives a read command (e.g., from the processor 202), the memory system controller 203 dynamically selects read data from one of the memory devices 204 to return to the processor 202, such as by dynamically selecting read data from a channel that did not have an ECC error (e.g., an uncorrectable error), among other examples. Put another way, in some implementations, when the memory system controller 203 receives, from the processor 202, a read command associated with data to be read from memory, the memory system controller 203 reads the data from both memory devices 204 or channels, determines whether a first copy of data stored in the primary memory device 204-1 or a second copy of the data stored in the redundant memory device 204-2 includes an error, and thus selectively transmits, to the processor 202, the first copy of data from the primary memory device 204-1 or the second copy of data from the redundant memory device 204-2 based on the determination of whether the first copy of the data or the second copy of data includes the error.

In some implementations, if the memory system controller 203 determines that data in a memory device 204 includes a correctable error (sometimes referred to herein as a correctable ECC (CECC)), the memory system controller 203 corrects the error before returning the data to the processor 202, and the memory system controller 203 writes back the corrected data to the memory 210 (such as via a write back (WB) operation performed by the read/write component 224 of the memory system controller 203, among other examples). Additionally, or alternatively, if a copy of the data has an uncorrectable error (sometimes referred to herein as an uncorrectable ECC (UECC)), the copy of data from the other memory device 204 is returned to the processor 202. For example, if the copy of the data stored in the primary memory device 204-1 includes an uncorrectable error, the copy of the data stored in the redundant memory device 204-2 is returned to the processor 202.

In that regard, upon receiving a read command, the memory system 200 dynamically determines which copy of the data (e.g., the copy of the data stored in the primary memory device 204-1, sometimes referred to herein as “primary data” for ease of description, or the copy of the data stored in the redundant memory device 204-2, sometimes referred to herein as “redundant data”) is returned to the processor 202 based on whether the primary data includes a correctable error (e.g., CECC) or uncorrectable error (e.g., UECC). For example, if both the primary data and the redundant data include no errors, the memory system 200 returns the primary data to the processor 202 (e.g., the primary memory device 204-1 is the default memory device and thus read requests are serviced from the primary memory device 204-1, when possible).

Moreover, if the primary data includes no errors and the redundant data includes a correctable error, the memory system 200 returns the primary data to the processor 202. In this case, the memory system 200 corrects the redundant data and, in some implementations, writes the corrected redundant data back to the memory 210-2. Moreover, if the primary data includes a correctable error and the redundant data includes no errors, the memory system 200 corrects the error and then returns the primary data to the processor 202. In some implementations, the memory system 200 also writes the corrected primary data back to the memory 210-2. And if both the primary data and the redundant data include a correctable error, the memory system 200 corrects the errors and then returns the primary data to the processor 202. In some implementations, the memory system 200 also writes the corrected primary data and the corrected redundant data back to the memory 210-1 and the memory 210-2, respectively.

Moreover, if the primary data includes no errors and the redundant data includes an uncorrectable error, the memory system 200 returns the primary data to the processor 202. If the primary data includes an uncorrectable error and the redundant data includes no errors, the memory system returns the redundant data to the processor 202. And if both the primary data and the redundant data include an uncorrectable error, the memory system 200 returns the primary data to the processor 202 with an uncorrectable error status (e.g., an UECC status). In this case, the memory system 200 may also trigger an interrupt condition, among other examples.

In some implementations, the memory system 200 (more particularly, the SEFI controllers 206 or the dual SEFI component 222 of the memory system 200) is configured to determine that a SEFI condition has occurred for one of the memory devices 204 and thus reset the memory device 204, accordingly. Put another way, based on information received from the SEFI controller 206-1 associated with the primary memory device 204-1 or the SEFI controller 206-2 associated with the redundant memory device 204-1, the memory system 200 may determine that a SEFI condition associated with the primary memory device 204-1 or the redundant memory device 204-2 has occurred, and thus the memory system 200 (e.g., the reset controller 214 of the respective SEFI controller 206) resets the primary memory device 204-1 or the redundant memory device 204-2 (e.g., to recover from the SEFI condition) based on determining that the SEFI condition has occurred. In such implementations, the memory system 200 services any requests received from the processor 202 during the reset period from the memory device 204 not being reset. For example, if, while the memory system 200 is resetting the primary memory device 204-1, the memory system 200 receives an access request, the memory system 200 will complete the access request using the redundant memory device 204-2.

In some implementations, after resetting a memory device 204, the memory system 200 mirrors data from the memory device 204 that was not reset to the memory device 204 that was reset, such as for a purpose of maintaining coherency across the redundant memory devices 204. More particularly, returning to the example above in which the primary memory device 204-1 is reset and thus all access requests are serviced from the redundant memory device 204-2 while the primary memory device 204-1 is being reset, the memory system 200 copies, after the primary memory device 204-1 has been reset, data from the redundant memory device 204-2 to the primary memory device 204-1. In this way, upon detection of a SEFI condition for a specific memory device 204, the memory system 200 resets (e.g., power cycles) that memory device 204, retrains the memory link (e.g., the DDR link) after reset, and after link training is complete, mirrors memory content from the redundant channel to the primary channel to ensure that data is duplicated in both memories 210 after the power cycle. In some implementations, traffic from the processor 202 may be stalled for a short period of time during the memory copy operation.

During a memory device 204 reset or power cycle (e.g., in response to determining that a SEFI condition has occurred for the memory device 204), the entire memory subsystem (e.g., the entire DDR subsystem) is reset in order to recover from the memory failure. Accordingly, all subsystem components (e.g., the corresponding SEFI controller 206, memory device controller 207, physical layer interface component 208, and memory 210 (e.g., SDRAM)) of the corresponding memory device 204 are reset, with the corresponding link (e.g., DDR Link) being retrained after reset, as described above.

In some implementations, a SEFI condition is determined for given memory device 204 based on an error counter associated with the memory device 204 satisfying a threshold. More particularly, in some implementations, a quantity of uncorrectable errors are tracked for each memory device 204 by a respective SEFI controller 206, and, more particularly, by a respective SEFI tracking component 212 of the SEFI controller 206. In such implementations, upon detection of an uncorrectable error for a given memory device 204, the respective SEFI controller 206 increments a SEFI uncorrectable error counter. Once the uncorrectable error counter satisfies a SEFI threshold, the corresponding memory device 204 is reset, as described above.

Additionally, or alternatively, in some implementations, a quantity of correctable errors are tracked for each memory device 204 by a respective SEFI controller 206, and, more particularly, by a respective SEFI tracking component 212 of the SEFI controller 206. In such implementations, the SEFI controller 206 of each memory device 204 (more particularly, the SEFI tracking component 212 of the SEFI controller 206) tracks correctable errors at the respective memory 210 of the memory device 204 and determines that a SEFI condition has occurred when a certain quantity of correctable errors have occurred (e.g., four correctable errors, in some implementations). In some implementations, the correctable error counter threshold is programmable by the processor 202 (e.g., the programming interface 205), with a default value being set to four. Moreover, the correctable error counter may be cleared following a memory device 204 reset (e.g., a power cycle), among other examples.

In some implementations, the SEFI correctable error counter is incremented for each correctable error detected for a given portion of memory 210 and decremented when a particular access to that portion of memory 210 returns no correctable errors. Put another way, the SEFI controller 206 increments a correctable error counter for every time that data from a given row or column is returned with a correctable error and decrements the correctable error counter for every time that data from that row or column is returned without an error. In such implementations, the correctable error counter is not decremented if an uncorrectable error is detected for that row or column or if the correctable error counter is at zero.

In some implementations, the memory system 200 (more particularly, a scrubber component 226 of the memory system controller 203 of the memory system 200) is configured to perform a scrubbing operation to proactively identify errors in data stored in the memory devices 204 and correct the errors in the data (e.g., using an EDAC capability of the memory system 200 and/or the EDAC component 216 of a memory device 204). In such implementations, upon detecting and correcting an error in one of the primary memory device 204-1 or the redundant memory device 204-2, the memory system 200 writes the corrected data to both the primary memory device 204-1 and to the redundant memory device 204-2, such as for a purpose of ensuring memory coherency between the two memory devices 204.

More particularly, during a scrubbing operation, the memory system 200 reads every location in the memory 210 sequentially and writes back any corrected data to the memory 210. In some implementations, the scrubbing read and write-back are atomic, and data coherency is maintained during the scrubbing operation. Moreover, any read or write request to the same address being scrubbed is put aside in a pending conflict queue, and the memory system 200 services the request once the scrubbing is complete. In order to maintain data coherency between the primary memory device 204-1 and the redundant memory device 204-2, the scrubbing operation is performed on both memory devices 204 or channels simultaneously. For example, a scrubbing request is issued from a single scrubber (e.g., the scrubber component 226) and the scrubbing request is broadcast to both memory devices 204 or channels. In some implementations, the scrubber component 226 waits for the request sent to both memory devices 204 or channels to complete, and, if a correctable error is detected in read data returned from either channel, the data is corrected and written back to memory 210 in both channels.

In implementations in which the memory 210 is associated with DRAM (e.g., SDRAM in DDR applications, among other examples), the memory devices 204 may be periodically refreshed. In some implementations, the primary memory device 204-1 and the redundant memory device 204-2 may be refreshed in parallel, such as for a purpose of maintaining data coherency between the two memory devices 204. For example, a refresh command is issued to both channels or memory devices 204 based on a single user-initiated refresh (e.g., based on receiving a refresh command from the processor 202). In some other implementations, each memory controller 207 initiates a respective refresh operation for a corresponding memory device 204 and each channel is independently and asynchronously refreshed to each other.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

FIG. 3 is a diagram of an example implementation 300 associated with Hamming-5 EDAC protection of data stored in redundant memory devices of a memory system. As shown in FIG. 3, example implementation 300 includes multiple memory components 302 (shown as a first memory component 302-1 through an eighth memory component 302-8), which, in some implementations, correspond to the memory arrays 130 described above in connection with FIG. 1 or the memory 210 described above in connection with FIG. 2.

As described above, in some implementations, data stored in redundant memory channels (e.g., in the primary memory device 204-1 and the redundant memory device 204-2) is associated with Hamming-5 EDAC protection. More particularly, a first copy of data stored in the primary memory device 204-1 is associated with a Hamming-5 EDAC capability of the primary memory device 204-1, and a second copy of the data stored in the redundant memory device 204-2 is associated with a Hamming-5 EDAC capability of the redundant memory device 204-2.

In such implementations, and as indicated by reference number 304, Hamming- 5 EDAC is associated with generating and storing 256 parity bits for every 256 bits of data (e.g., each byte of data generates one byte of parity bits), which enables single-bit and double-bit error correction for the 256 bits of data. In such implementations, data is interleaved across an entire memory interface, such that each physical memory component 302 (with each memory component being associated with eight DQ pins and thus configured in a “by-eight” or “x8” mode) holds two bits from every byte of data and two corresponding parity bits. In that way, for 256 bits of data, each memory component 302 stores 32 data bits and 32 parity or EDAC bits. More particularly, as shown in detail in connection with the first memory component 302-1, for every 256 bits of data, a memory component 302 stores eight data bytes (indexed Data Byte 0 through Data Byte 3) and four parity bytes (indexed as Parity Byte 0 through Parity Byte 3). In this way, each x8 access of the first memory component 302-1 includes accessing information from each of the data bytes and each of the parity bytes, as shown using similar shading in connection with the data and parity bytes and the example x8 accesses shown in FIG. 3.

Although FIG. 3 shows example implementation 300 associated with Hamming-5 EDAC, in some other implementations, the copies of the data at the memories 210 may be associated with an EDAC protection other than Hamming-5 EDAC protection. For example, in some other implementations, the copies of the data at the memories 210 may be associated with SECDED protection or Hamming-3 EDAC protection, among other examples.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

FIG. 4 is a diagram of an example environment 400 in which systems and/or methods described herein may be implemented. As shown in FIG. 4, environment 400 may include a satellite 405 including a memory system 410 (e.g., memory system 110 or memory system 200) and a processor 415 (e.g., host processor 150 or processor 202). In some implementations, the memory system 410 includes a memory system controller 420 (e.g., memory system controller 115 or memory system controller 203) that is in communication with the processor 415 and multiple memory devices or channels (e.g., memory devices 120, memory devices 204, and/or corresponding channels), shown as a primary memory device 425 (e.g., primary memory device 204-1) and a redundant memory device 430 (e.g., redundant memory device 204-2).

In a similar manner as described above in connection with memory system 200 of FIG. 2, by employing the primary memory device 425 and the redundant memory device 430 in the satellite 405, the satellite 405 (more particularly, the memory system 410 of the satellite 405) is more resilient to SEFI conditions or FITs, resulting in more reliable operation as compared to satellites employing only a single memory device or channel. More particularly, in a similar manner as described above in connection with FIG. 2, the multiple memory devices 425, 430 or channels enable auto-correction of bit errors, memory part failure detection, and data recovery, among other examples, thereby enabling the use of certain memory systems (e.g., DDR-based systems) in single event effect (SEE) environments (e.g., environments susceptible to SEEs, or disturbances in the semiconductor device caused by cosmic rays or ionizing radiation, among other examples).

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

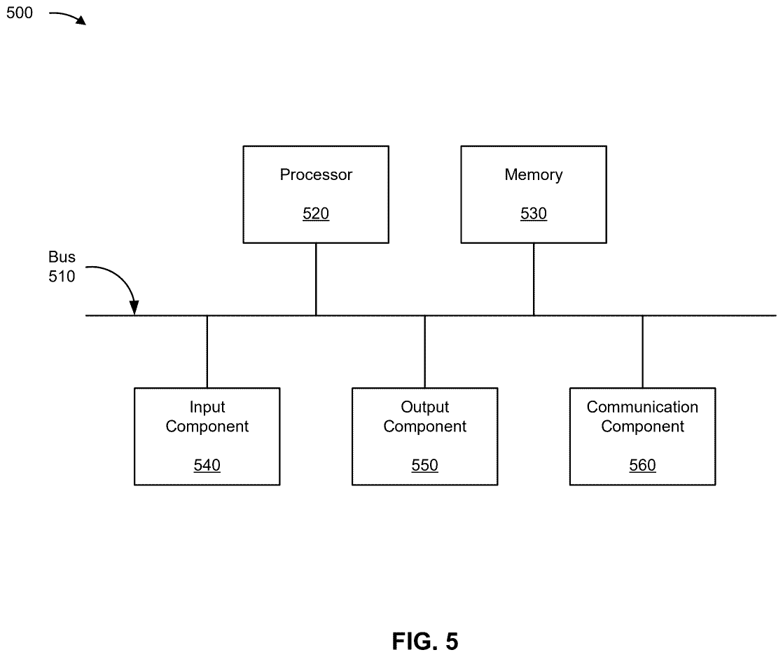

FIG. 5 is a diagram of example components of a device 500 associated with selective transmission of data stored in redundant memory devices of a memory system. The device 500 corresponds to one or more of host system 105, memory system 110, memory device 120, memory system 200, primary memory device 204-1, redundant memory device 204-2, satellite 405, memory system 410, processor 415, primary memory device 425, and/or redundant memory device 430. In some implementations, host system 105, memory system 110, memory device 120, memory system 200, primary memory device 204-1, redundant memory device 204-2, satellite 405, memory system 410, processor 415, primary memory device 425, and/or redundant memory device 430 includes one or more devices 500 and/or one or more components of the device 500. In the example shown in FIG. 5, the device 500 includes a bus 510, a processor 520, a memory 530, an input component 540, an output component 550, and/or a communication component 560.

The bus 510 includes one or more components that enable wired and/or wireless communication among the components of the device 500. The bus 510 couples together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 includes one or more processors capable of being programmed to perform one or more operations or processes described elsewhere herein.

The memory 530 includes volatile and/or nonvolatile memory, such as RAM, ROM, a hard disk drive, and/or another type of memory (e.g., a flash memory, a magnetic memory, an optical memory, and/or a DDR-based memory). The memory 530 may include internal memory (e.g., RAM, ROM, or a hard disk drive) and/or removable memory (e.g., removable via a universal serial bus connection). In some implementations, the memory 530 is a non-transitory computer-readable medium. The memory 530 stores information, one or more instructions, and/or software (e.g., one or more software applications) related to the operation of the device 500. In some implementations, the memory 530 includes one or more memories that are coupled (e.g., communicatively coupled) to one or more processors (e.g., processor 520), such as via the bus 510. Communicative coupling between a processor 520 and a memory 530 enables the processor 520 to read and/or process information stored in the memory 530 and/or to store information in the memory 530.

The input component 540 enables the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 enables the device 500 to provide output, such as via a display, a speaker, and/or a light-emitting diode. The communication component 560 enables the device 500 to communicate with other devices via a wired connection and/or a wireless connection. For example, the communication component 560 may include a receiver, a transmitter, a transceiver, a modem, a network interface card, and/or an antenna.

In some implementations, the device 500 performs one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry is used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

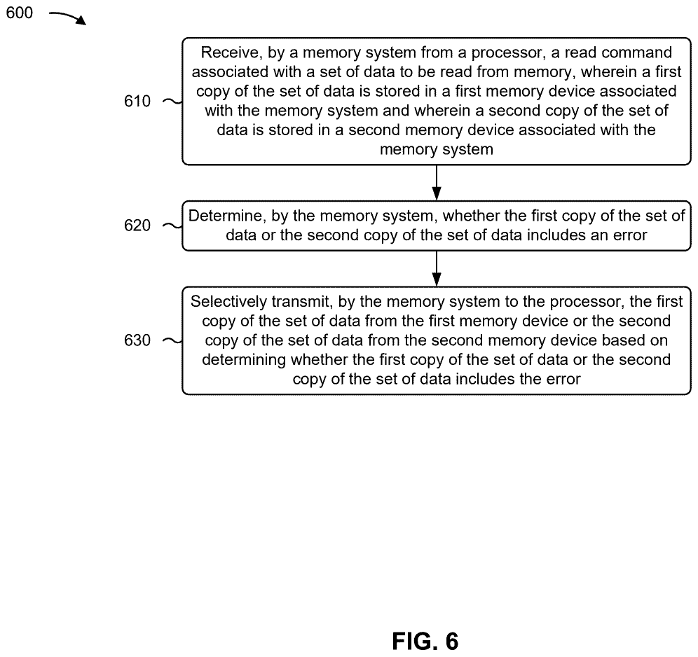

FIG. 6 is a flowchart of an example process 600 associated with selective transmission of data stored in redundant memory devices of a memory system. One or more process blocks of FIG. 6 are performed by a memory system (e.g., memory system 200 and/or memory system 410) and/or by another device or a group of devices separate from or including the memory system, such as a processor (e.g., processor 202 and/or processor 415), a memory system controller (e.g., memory system controller 203 and/or memory system controller 420), and/or one or more memory devices (e.g., primary memory device 204-1, redundant memory device 204-2, primary memory device 425, and/or redundant memory device 430). Additionally, or alternatively, one or more process blocks of FIG. 6 may be performed by one or more components of device 500, such as processor 520, memory 530, input component 540, output component 550, and/or communication component 560.

As shown in FIG. 6, process 600 includes receiving a read command associated with a set of data to be read from memory, wherein a first copy of the set of data is stored in a first memory device associated with the memory system, and wherein a second copy of the set of data is stored in a second memory device associated with the memory system (block 610). For example, the memory system may receive a read command associated with a set of data to be read from memory, wherein a first copy of the set of data is stored in a first memory device associated with the memory system, and wherein a second copy of the set of data is stored in a second memory device associated with the memory system, as described above.

As further shown in FIG. 6, process 600 includes determining whether the first copy of the set of data or the second copy of the set of data includes an error (block 620). For example, the memory system may determine whether the first copy of the set of data or the second copy of the set of data includes an error, as described above.

As further shown in FIG. 6, process 600 includes selectively transmitting the first copy of the set of data from the first memory device or the second copy of the set of data from the second memory device based on determining whether the first copy of the set of data or the second copy of the set of data includes the error (block 630). For example, the memory system may selectively transmit the first copy of the set of data from the first memory device or the second copy of the set of data from the second memory device based on determining whether the first copy of the set of data or the second copy of the set of data includes the error, as described above.

Process 600 may include additional aspects, such as any single aspect or any combination of aspects described below and/or in connection with one or more other processes described elsewhere herein.

In a first aspect, process 600 includes receiving a write command associated with another set of data to be written to the memory, and writing a first copy of the other set of data to the first memory device and a second copy of the other set of data to the second memory device.

In a second aspect, alone or in combination with the first aspect, process 600 includes determining, using a SEFI controller associated with the first memory device, that a SEFI condition associated with the first memory device has occurred, and resetting, by the memory system, the first memory device based on determining that the SEFI condition associated with the first memory device has occurred.

In a third aspect, alone or in combination with the first through second aspects, process 600 includes receiving an access request during a period of time when the first memory device is being reset, and completing the access request using the second memory device.

In a fourth aspect, alone or in combination with the first through third aspects, process 600 includes copying, after the first memory device has been reset, data from the second memory device to the first memory device.

In a fifth aspect, alone or in combination with the first through fourth aspects, process 600 includes detecting, using the SEFI controller, multiple correctable errors associated with the first memory device; incrementing, using the SEFI controller, a correctable error counter associated with the first memory device based on detecting the multiple correctable errors associated with the first memory device; and determining, using the SEFI controller, that the SEFI condition has occurred based at least in part on the correctable error counter satisfying a threshold.

In a sixth aspect, alone or in combination with the first through fifth aspects, the first copy of the set of data stored in the first memory device is associated with a Hamming-5 EDAC capability of the first memory device, and the second copy of the set of data stored in the second memory device is associated with a Hamming-5 EDAC capability of the second memory device.

In a seventh aspect, process 600 includes performing a scrubbing operation to identify at least one error in data stored in the first memory device; correcting the at least one error in the data stored in the first memory device, resulting in corrected data; and writing the corrected data to the first memory device and to the second memory device.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations described herein to the precise forms that are described. Modifications and variations can be made in light of the above description or may be acquired from practice of the implementations described herein.

As used herein, the term “component” is intended to be broadly construed as hardware, firmware, and/or a combination of hardware and software. It will be apparent that systems and/or methods described herein can be implemented in different forms of hardware, firmware, or a combination of hardware and software. The actual specialized control hardware or software code used to implement these systems and/or methods is not limiting of the implementations described herein. Thus, the operation and behavior of the systems and/or methods are described herein without reference to specific software code-it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or described in the specification, these combinations are not intended to limit the implementations described herein. In fact, many of these features can be combined in ways not specifically recited in the claims and/or described in the specification. For example, the description includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a component” or “one or more components” (or another element, such as “a processor” or “one or more processors”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and can be used interchangeably with “one or more.” Further, as used herein, the article “the” is intended to include one or more items referenced in connection with the article “the” and can be used interchangeably with “the one or more.” Furthermore, as used herein, the term “set” is intended to include one or more items (e.g., related items, unrelated items, or a combination of related and unrelated items,), and can be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and can be used interchangeably with “and/or,” unless explicitly stated otherwise (e.g., if used in combination with “either” or “only one of”).

1. A memory system, comprising:
a first memory device;
a second memory device; and
a memory system controller operatively coupled to the first memory device and the second memory device, the memory system controller configured to:
receive, from a processor, a read command associated with a first set of data to be read from memory,
wherein a first copy of the first set of data is stored in the first memory device and wherein a second copy of the first set of data is stored in the second memory device, and
wherein the read command is sent to both a first memory channel associated with the first memory device-and a second memory channel associated with the second memory device;
determine whether the first copy of the first set of data or the second copy of the first set of data includes an error; and
selectively transmit, to the processor, the first copy of the first set of data from the first memory device or the second copy of the first set of data from the second memory device based on the determination of whether the first copy of the first set of data or the second copy of the first set of data includes the error.

2. The memory system of claim 1, wherein the memory system controller is further configured to:
receive, from the processor, a write command associated with a second set of data to be written to the memory; and
write a first copy of the second set of data to the first memory device and write a second copy of the second set of data to the second memory device.

3. The memory system of claim 1, wherein the memory system controller is further configured to:
determine, based on information received from a single event functional interrupt (SEFI) controller associated with the first memory device, that a SEFI condition associated with the first memory device has occurred; and
reset the first memory device based on determining that the SEFI condition associated with the first memory device has occurred.

4. The memory system of claim 3, wherein the memory system controller is further configured to:
receive, from the processor, an access request during a period of time when the first memory device is being reset; and
complete the access request using the second memory device.

5. The memory system of claim 3, wherein the memory system controller is further configured to:
copy, after the first memory device has been reset, data from the second memory device to the first memory device.

6. The memory system of claim 3, wherein the SEFI controller associated with the first memory device is configured to:
detect multiple correctable errors associated with the first memory device;
increment a correctable error counter associated with the first memory device based on detecting the multiple correctable errors associated with the first memory device; and
determine that the SEFI condition has occurred based at least in part on the correctable error counter satisfying a threshold.

7. The memory system of claim 1, wherein the first copy of the first set of data stored in the first memory device is associated with a Hamming-5 error detection and correction (EDAC) capability of the first memory device, and
wherein the second copy of the first set of data stored in the second memory device is associated with a Hamming-5 EDAC capability of the second memory device.

8. The memory system of claim 1, wherein the memory system controller is further configured to:
perform a scrubbing operation to identify at least one error in data stored in the first memory device;
correct the at least one error in the data stored in the first memory device to create corrected data; and
write the corrected data to the first memory device and to the second memory device.

9. A method, comprising:
receiving, by a memory system from a processor, a read command associated with a first set of data to be read from memory,
wherein a first copy of the first set of data is stored in a first memory device associated with the memory system and wherein a second copy of the first set of data is stored in a second memory device associated with the memory system, and
wherein the read command is sent to both a first memory channel associated with the first memory device-and a second memory channel associated with the second memory device;
determining, by the memory system, whether the first copy of the first set of data or the second copy of the first set of data includes an error; and
selectively transmitting, by the memory system to the processor, the first copy of the first set of data from the first memory device or the second copy of the first set of data from the second memory device based on determining whether the first copy of the first set of data or the second copy of the first set of data includes the error.

10. The method of claim 9, further comprising:
receiving, by the memory system from the processor, a write command associated with a second set of data to be written to the memory; and
writing, by the memory system, a first copy of the second set of data to the first memory device and a second copy of the second set of data to the second memory device.

11. The method of claim 9, further comprising:
determining, by the memory system using a single event functional interrupt (SEFI) controller associated with the first memory device, that a SEFI condition associated with the first memory device has occurred; and
resetting, by the memory system, the first memory device based on determining that the SEFI condition associated with the first memory device has occurred.

12. The method of claim 11, further comprising:
receiving, by the memory system and from the processor, an access request during a period of time when the first memory device is being reset; and
completing, by the memory system, the access request using the second memory device.

13. The method of claim 11, further comprising:
copying, by the memory system and after the first memory device has been reset, data from the second memory device to the first memory device.

14. The method of claim 11, further comprising:
detecting, by the memory system using the SEFI controller, multiple correctable errors associated with the first memory device;
incrementing, by the memory system using the SEFI controller, a correctable error counter associated with the first memory device based on detecting the multiple correctable errors associated with the first memory device; and
determining, by the memory system using the SEFI controller, that the SEFI condition has occurred based at least in part on the correctable error counter satisfying a threshold.

15. The method of claim 9, wherein the first copy of the first set of data stored in the first memory device is associated with a Hamming-5 error detection and correction (EDAC) capability of the first memory device, and
wherein the second copy of the first set of data stored in the second memory device is associated with a Hamming-5 EDAC capability of the second memory device.

16. The method of claim 9, further comprising:
performing, by the memory system, a scrubbing operation to identify at least one error in data stored in the first memory device;
correcting, by the memory system, the at least one error in the data stored in the first memory device, resulting in corrected data; and
writing, by the memory system, the corrected data to the first memory device and to the second memory device.

17. A non-transitory computer-readable medium storing a set of instructions, the set of instructions comprising:
one or more instructions that, when executed by one or more processors of a memory system, cause the memory system to:
receive a read command associated with a first set of data to be read from memory,
wherein a first copy of the first set of data is stored in a first memory device associated with the memory system and wherein a second copy of the first set of data is stored in a second memory device associated with the memory system, and
wherein the read command is sent to both a first memory channel associated with the first memory device-and a second memory channel associated with the second memory device;
determine whether the first copy of the first set of data or the second copy of the first set of data includes an error; and
selectively transmit the first copy of the first set of data from the first memory device or the second copy of the first set of data from the second memory device based on determining whether the first copy of the first set of data or the second copy of the first set of data includes the error.

18. The non-transitory computer-readable medium of claim 17, wherein the one or more instructions further cause the memory system to:
receive a write command associated with a second set of data to be written to the memory; and
write a first copy of the second set of data to the first memory device and a second copy of the second set of data to the second memory device.

19. The non-transitory computer-readable medium of claim 17, wherein the one or more instructions further cause the memory system to:
determine that a SEFI condition associated with the first memory device has occurred; and
reset the first memory device based on determining that the SEFI condition associated with the first memory device has occurred.

20. The non-transitory computer-readable medium of claim 19, wherein the one or more instructions further cause the memory system to:
receive an access request during a period of time when the first memory device is being reset; and
complete the access request using the second memory device.
